(19) United States
(12) Patent Application Publication
(10) Pub. No.: US 2025/0196572 A1
(43) Pub. Date: Jun. 19, 2025

(54) AIR CONDITIONER FOR VEHICLE

(71) Applicant: Hanon Systems, Daejeon (KR)

(72) Inventors: Jun Chul An, Daejeon (KR); Sang Ki Lee, Daejeon (KR); Yong Sik Kim, Daejeon (KR)

(21) Appl. No.: 18/971,230

(22) Filed: Dec. 6, 2024

(30) Foreign Application Priority Data
Dec. 15, 2023 (KR) 10-2023-0182592

(51) Int. Cl. B60H 1/00

(52) U.S. Cl. CPC B60H 1/00692

(57) ABSTRACT

In a structure in which a door and a case sealing part are in surface contact with each other at the downstream side in an air flow direction, an air conditioner for a vehicle that enabling easier assembly of the door is disclosed. The air conditioner includes: an air conditioning case in which an air passage and a plurality of air discharge ports are formed; a cooling heat exchanger and a heating heat exchanger sequentially arranged in the air passage of the air conditioning case in an airflow direction; and a sliding-type door for adjusting the opening degree of the air passage, wherein a rail part is formed in the air conditioning case to guide the sliding of the door, and a separate assembly is coupled to the air conditioning case and is in close contact with the door inserted into the rail part to form a sealing surface.

### BACKGROUND OF THE PRESENT INVENTION

### Field of the Present Invention

The present invention relates to an air conditioner for a vehicle, and more specifically, to an air conditioner for a vehicle which includes a thin sliding type door controlling the opening degree of an air passage within an air conditioning case.

### Background Art

In general, the vehicle air conditioner is a vehicle interior component that is installed for the purpose of cooling or heating the vehicle interior in the summer or winter, of securing the driver's front and rear view by removing the frost from the windshield during the rain or winter season. As such, the air conditioner is usually equipped with a heating device and a cooling device at the same time to selectively introduce the outside air or inside air, and then heats or cools the air and blows it into the vehicle interior, thereby cooling, heating, or ventilating the interior of the vehicle.

Referring to FIG. 1, a conventional air conditioner 1 for a vehicle includes an air conditioning case 10, an evaporator 20 which is a cooling heat exchanger, an indoor condenser 30 which is a heating heat exchanger, and a temperature door 40. The evaporator 20 and the indoor condenser 30 are sequentially arranged inside the air conditioning case 10 in an air flow direction. Downstream of the indoor condenser 30 in the air flow direction, an electric heater such as a PTC heater can be provided.

The temperature door 40 adjusts the opening degree of a warm air passage 15 passing through the indoor condenser 30 and a cold air passage 14 bypassing the indoor condenser 30, thereby controlling the interior temperature of the vehicle. The air conditioning case 10 includes a plurality of air discharge ports: a defrost vent 11, a face vent 12, and a floor vent 13. The defrost vent 11 discharges wind towards the vehicle window, the face vent 12 discharges wind towards passengers' faces, and the floor vent 13 discharges wind towards the passengers' feet.

Additionally, the air conditioning case 10 includes a plurality of mode doors to control the opening degree of the air discharge ports. That is, the air conditioning case 10 includes a defrost door 51 for controlling the opening degree of the defrost vent 11, a vent door 52 for controlling the opening degree of the face vent 12, and a floor door 53 for controlling the opening degree of the floor vent 13. The temperature door 40 is designed in a sliding type, and has a rail-shaped guide groove 60 formed on the inner wall of the air conditioning case 10 to guide the temperature door 40.

The temperature door 40 has a driven gear 43 that meshes with a driving gear 70. The temperature door 40 slidably moves along the guide groove 60 by the rotation of the driving gear 70. The guide groove 60 extends in a convex arc shape in the wind direction, and the temperature door 40 is correspondingly curved to fit the guide groove 60. The driving gear 70 has a drive shaft 71 extending in the width direction of the door.

In conventional air conditioner for a vehicle, the sliding type door must be assembled by being pushed into the air conditioning case through an opening like the defrost vent. However, due to the layout of the air conditioning case 10, there is no space to assemble the sliding door, so it is impossible or difficult to assemble the sliding type door.

### SUMMARY OF THE PRESENT INVENTION

Accordingly, the present invention has been made to solve the above-mentioned problems occurring in the prior arts, in a structure in which a door and a case sealing part are in surface contact with each other at the downstream side in an air flow direction, it is an objective of the present invention to provide an air conditioner for a vehicle that enabling easier assembly of the door.

To accomplish the above object, according to the present invention, there is provided an air conditioner for a vehicle including: an air conditioning case in which an air passage and a plurality of air discharge ports are formed; a cooling heat exchanger and a heating heat exchanger sequentially arranged in the air passage of the air conditioning case in an airflow direction; and a sliding-type door for adjusting the opening degree of the air passage, wherein a rail part is formed in the air conditioning case to guide the sliding of the door, and a separate assembly is coupled to the air conditioning case and is in close contact with the door inserted into the rail part to form a sealing surface.

The separate assembly is detachably coupled to the air conditioning case.

The door has a thin plate shape, and the rail part supports at least one side of the door in a door thickness direction.

A cut portion is formed on one side of the rail part in the door thickness direction, inserted and assembled through the cut portion.

When the separate assembly is coupled to the air conditioning case, the sealing surface of the separate assembly is positioned in the cut portion to support the door.

The separate assembly has a mesh-shaped vent part.

The door is a mode door for adjusting the opening degree of the air discharge port, and the separate assembly includes a discharge port grille to prevent the ingress of foreign objects.

The mode door includes a defrost door for adjusting the opening degree of a defrost vent that directs air towards the window, and the separate assembly covers the discharge port of the defrost vent.

The separate assembly and the sealing surface are integrally formed.

The separate assembly has a coupling part of a hook-type fastening structure to be detachably coupled to the air conditioning case.

The internal passage of the air conditioning case is formed vertically relative to the ground surface to direct the airflow route from the bottom to the top in the direction of gravity. The cooling and heating heat exchangers on the internal passage are sequentially arranged from the bottom to the top corresponding to the air flow route formed from the bottom to the top in the direction of gravity.

The separate assembly has a shape corresponding to that of the discharge port of the air discharge port. The sealing surface is formed on both sides and the central part of the separate assembly in the vehicle width direction, and the sealing surface formed at the central part corresponds to a separator that divides the air passage of the air conditioning case in the vehicle width direction.

The cut portion and the separate assembly are formed downstream of the door in the airflow direction.

The door is inserted and assembled into the rail part from the outside of the air conditioning case through the air discharge port.

The door has a tension part that is elastically supported on the rail part, and the side of the door which contacts the sealing surface is formed on the opposite side where the tension part is formed.

The cut portion is formed on the opposite side of the tension part of the door.

According to the present invention, in the air conditioner for a vehicle, the sealing surface formed on a separate assembly fills the empty space as big as the cut portion formed to assemble the defrost door, thereby providing a sealing function and a defrost door slide guiding function. That is, through the configuration of the separate assembly, the air conditioner for a vehicle according to the present invention can enhance the assembly process of the door and prevent air leakage.

### BRIEF DESCRIPTION OF THE DRAWINGS

FIG. 1 is a side sectional view illustrating a conventional air conditioner for a vehicle.

FIG. 2 is a side sectional view illustrating an air conditioner for a vehicle according to an embodiment of the present invention.

FIG. 3 is a perspective view of a defrost door in the air conditioner for a vehicle according to an embodiment of the present invention.

FIG. 4 is a side sectional view illustrating an assembly process of the defrost door in the air conditioner for a vehicle according to an embodiment of the present invention.

FIG. 5 is a side sectional view illustrating a coupled state of a separate assembly in the condition of FIG. 4.

FIG. 6 is a plan view of the separate assembly in the air conditioner for a vehicle according to an embodiment of the present invention.

FIG. 7 is a plan view of the defrost vent to which the separate assembly is coupled in the air conditioner for a vehicle according to an embodiment of the present invention.

FIG. 8 is a sectional view taken along line A-A in FIG. 6.

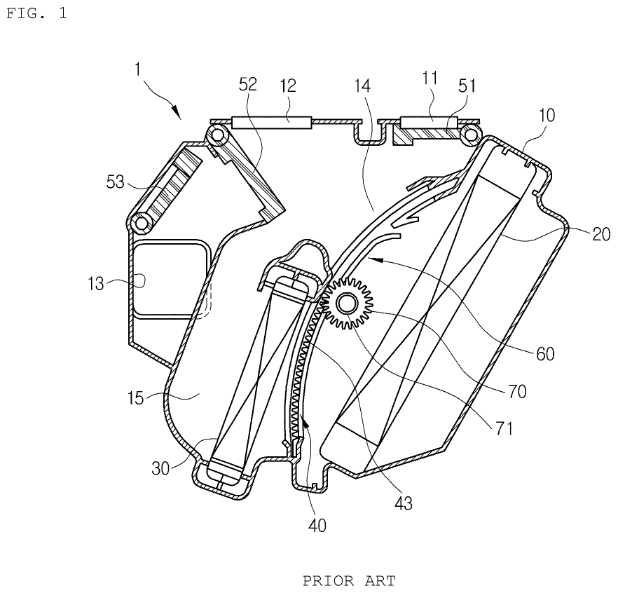

### DETAILED DESCRIPTION OF THE PREFERRED EMBODIMENT

Hereinafter, referring to the drawings, the technical configuration of an air conditioner for a vehicle will be described in detail.

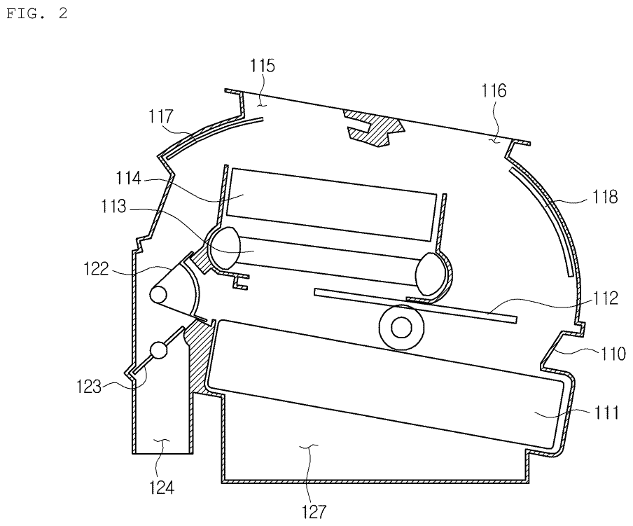

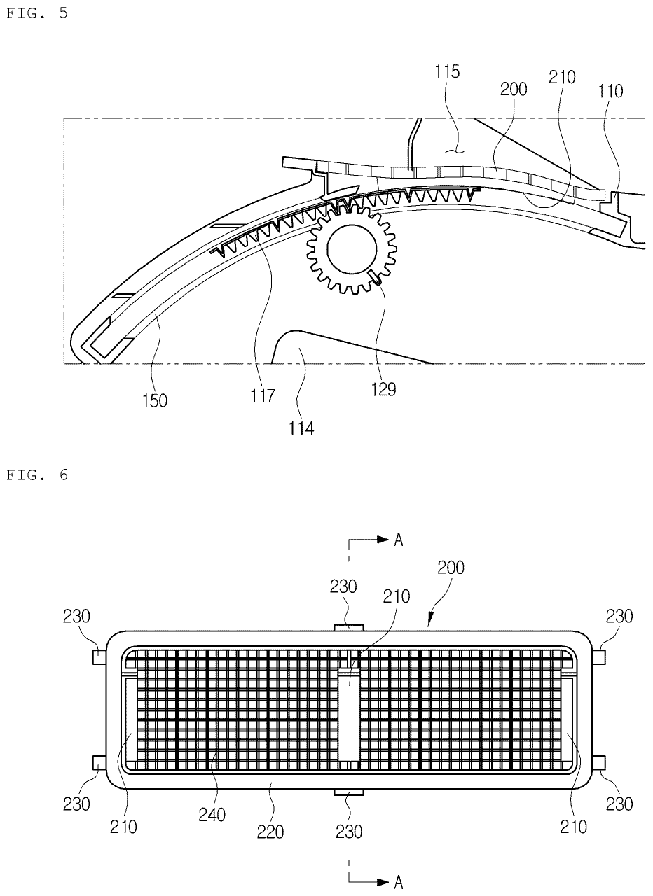

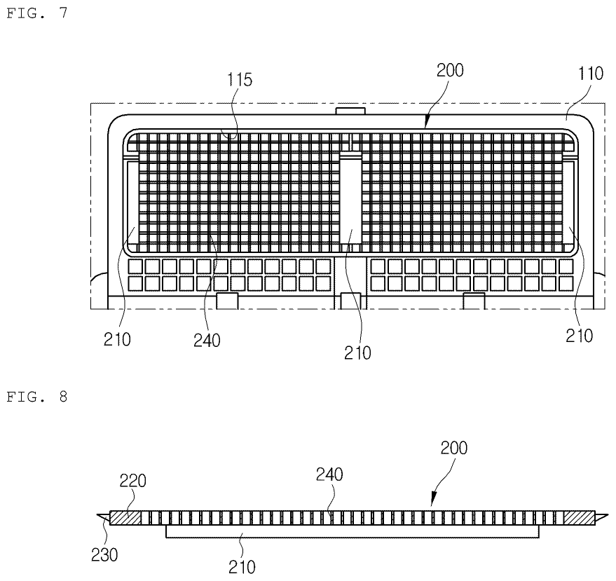

Referring to FIGS. 2 to 8, the air conditioner for a vehicle according to an embodiment of the present invention is a slim-type air conditioner with a horizontally arranged heat exchanger type, and has a relatively thin vertical width. The air conditioner for a vehicle according to an embodiment of the present invention includes an air conditioning case 110, a cooling heat exchanger, a heating heat exchanger, and a door. In the description below, the left-right direction in FIG. 2 corresponds to the vehicle's front-rear direction, while the left-right direction in FIG. 7 corresponds to the vehicle's width direction.

The air conditioning case 110 includes an air passage and is a slim type with a narrow vertical width. The air conditioning case 110 includes an air inflow port 127 and a plurality of air discharge ports. An air blower for blowing air into the air conditioning case 110 is connected to the air inflow port 127. The air blower selectively introduces inside air or outside air and blows the air into the air conditioning case 110.

Moreover, the air inflow port 127 is located below the cooling heat exchanger so that air flows from the bottom to the top. The air discharge ports of the air conditioning case 110 includes a front seat air discharge port for directing air to the front seats and a rear seat air discharge port for directing air to the rear seats. The front seat air discharge port includes a defrost vent 115 and a face vent 116, while the rear seat air discharge port includes a rear seat vent 124.

The defrost vent 115 directs air toward the vehicle windows, the face vent 116 directs air toward the front seat passengers' faces, and the floor vent directs air toward their feet. Additionally, the rear seat vent 124 includes a rear seat console, a B-pillar, and a rear seat floor vent.

The cooling heat exchanger is an evaporator 111, and the heating heat exchanger is an indoor condenser 113. An electric heater 114 such as a PTC heater is provided downstream of the indoor condenser 113 in the airflow direction. The evaporator 111 and the indoor condenser 113 are connected in a refrigerant circulation line connecting a compressor, an expansion valve, etc., to act as a cooling means or a heating means depending on the refrigerant state. That is, the refrigerant passing through the evaporator 111 exchanges heat with air to cool the air, and the refrigerant passing through the indoor condenser 113 exchanges heat with air to heat the air.

The evaporator 111 and the indoor condenser 113 are sequentially arranged in the air passage of the air conditioning case 110 in the airflow direction. The evaporator 111, the indoor condenser 113, and the electric heater 114 are all arranged horizontally. That is, the internal passage of the air conditioning case 110 is vertically oriented relative to the ground, directing the airflow route from the lower part to the upper part in the direction of gravity. In addition, the cooling heat exchanger and the heating heat exchanger on the internal passage are arranged sequentially from the bottom to the top in the direction of gravity corresponding to the air flow route.

As described above, the heat exchangers are arranged horizontally relative to the ground surface or inclined at a predetermined angle to be close to the horizontal. That is, air is introduced into the air inflow port 127 at the lower side of the air conditioning case 110 and flows upwards. From below, the evaporator 111, the indoor condenser 113, and the electric heater 114 are arranged in sequence.

The door, which controls the opening degree of the internal airflow passages of the air conditioning case 110, is formed as a sliding type. The door includes a temperature door 112 and a plurality of mode doors.

The temperature door 112 is placed between the evaporator 111 and the indoor condenser 113. The temperature door 112 controls the opening degree between the warm air passage passing through the indoor condenser 113 and the cold air passage bypassing the indoor condenser 113 to adjust the interior temperature of the vehicle. That is, the temperature door 112 adjusts the amount of air passing through or bypassing the indoor condenser 113 and the electric heater 114 according to the position thereof. Additionally, the air conditioning case 110 includes a rear seat temperature door 122 which is arranged between the evaporator 111 and the indoor condenser 113 to regulate the temperature of the air flowing to the rear seat air discharge port.

The temperature door 112 is a plate door that slides horizontally within the air conditioning case 110, adjusting the opening degree between the cold air passage and the warm air passage. The sliding-type temperature door 112 helps reduce the height of the air conditioning case 110. Furthermore, a separator which divides the left and right of the inside of the air conditioning case 110 in a vehicle width direction, performing right and left independent air conditioning for the driver's seat and the front passenger's seat.

Meanwhile, the rear seat air discharge port is placed in front of the front seat air discharge port. That is, the rear seat vent 124, which is a rear seat air discharge port, is located on the front side of the air conditioning case 110. The defrost vent 115 and the face vent 116, which are front seat air discharge ports are positioned behind the rear seat vent 124. The defrost vent 115 and the face vent 116 are formed on the top of the air conditioning case 110, and the defrost vent 115 is arranged in front of the face vent 116.

The mode doors include a defrost door 117 for adjusting the opening degree of the defrost vent 115, a vent door 118 for adjusting the opening degree of the face vent 116, and a rear seat air volume door 123 for adjusting the opening degree of the rear seat vent 124.

Meanwhile, a rail part 150 is formed in the air conditioning case 110. The rail part 150 guides the sliding of the door. The thin door is inserted into the rail part 150 for assembly into the air conditioning case 110. The rail part 150 is designed to support at least one side of the door in the thickness direction of the door. The rail part 150 has a pair of walls spaced apart from each other at a predetermined interval, and the door is inserted into an empty space between the pair of walls.

The rail parts 150 are formed to protrude on both inner walls of the air conditioning case 110 in the vehicle width direction. Additionally, the rail part 150 protrudes on both sides of the separator in the vehicle width direction. The separator divides the air passage within the air conditioning case 110 in the vehicle width direction. A pair of defrost doors 117 are provided on both sides of the separator in the vehicle width direction.

One defrost door 117 is assembled by being inserted between the rail part 150 of one inner wall of the air conditioning case 110 and the rail part 150 of the separator, while the other defrost door 117 is assembled by being inserted between the rail part 150 of the opposite inner wall of the air conditioning case 110 and the rail part 150 of the separator.

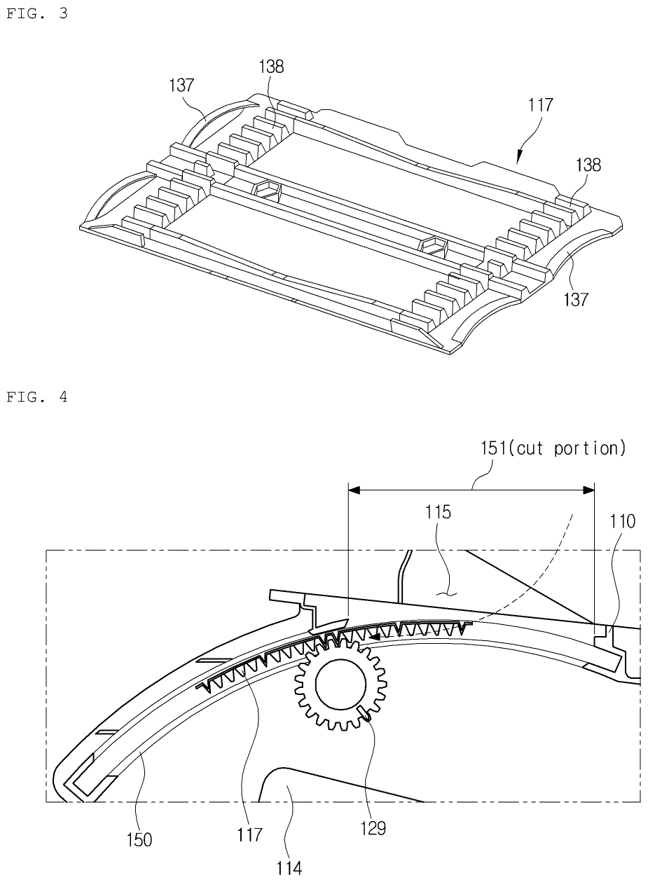

One side of the defrost door 117 has a gear 138 that engages with the drive shaft gear 129, and tension parts 137 are formed on both sides of the defrost door 117 in the vehicle width direction. The defrost door 117 is pushed into the empty space of the rail part 150 in the direction indicated by the dotted arrow in FIG. 4, completing the assembly into the air conditioning case 110. In the state in which the defrost door 117 is inserted into the rail part 150, the tension parts 137 formed on the edge of the defrost door 117 are inserted and supported in the rail part 150 and are tightly supported on the door sealing surface of the rail part 150. The tension parts 137 provide elastic support to the rail part 150.

The air conditioner for a vehicle according to an embodiment of the present invention includes a separate assembly 200. The separate assembly 200 is coupled to the air conditioning case 110, and forms a sealing surface 210 by being in close contact with the door inserted into the rail part 150. The separate assembly 200 is detachably coupled to the air conditioning case 110. That is, a coupling part 230 of hook-type fastening structure is formed on the separate assembly 200 to enable removable coupling to the air conditioning case 110.

The separate assembly 200 is configured to cover the discharge port of the defrost vent 115. A plurality of coupling parts 230 are formed along the edges of the separate assembly 200. The discharge port of the defrost vent 115 has fastening parts corresponding to the coupling parts 230 of the separate assembly 200. The separate assembly 200 is pressed downwards from above the air conditioning case 110 to cover the discharge port of the defrost vent 115 through a hook fastening structure.

The separate assembly 200 has a mesh-shaped vent part 240. That is, the separate assembly 200 has a structure of a discharge port grille to prevents foreign objects into the air conditioning case 110 through the defrost vent 115 from outside the vehicle. The separate assembly 200 and the sealing surface 210 are formed integrally. The shape of the separate assembly 200 corresponds to the shape of the air discharge port.

That is, the separate assembly 200 has a roughly rectangular plate-shaped body 220 that corresponds to the rectangular cross-section of the defrost vent 115, and has most of the area excluding the border made up of the mesh-shaped vent part 240. Through the vent part 240, air can pass smoothly while preventing foreign objects from entering the air conditioning case 110.

The sealing surface 210 is formed on one side in the thickness direction of the separate assembly 200. Additionally, the sealing surface 210 is formed on both sides and the central part of the body 220 in the vehicle width direction. The sealing surface 210 formed in the central part is arranged at a position corresponding to that of the separator. When the separate assembly 200 is coupled to the air conditioning case 110, the sealing surface 210 closely contacts by the tension part 137 of the defrost door 117 and supports the defrost door 117.

In addition, a cut portion 151 is formed in the air conditioning case 110. The cut portion 151 is located on one of both sides of the rail part 150 in the thickness direction of the door. That is, the cut portion 151 is formed by cutting (deleting) a portion of the downstream wall in the airflow direction among the pair of walls of the rail part 150. Through the cut portion 151, the defrost door 117 is inserted into the rail part 150, allowing the defrost door 117 to be assembled into the air conditioning case 110.

Meanwhile, the door is inserted and assembled from the outside of the air conditioning case 110 through the air discharge port into the rail part 150. That is, the defrost door 117 is inserted and assembled into the rail part 150 through the defrost vent 115 from outside the air conditioning case 110. Moreover, the side of the defrost door 117 contacting the sealing surface 210 is opposite the side on which the tension part 137 is formed. Furthermore, the cut portion 151 is formed on the opposite side of the tension part 137 of the defrost door 117. This is because the opposite side of the door has a wider contact area with the rail part 150 than the tension part 137, requiring enhanced sealing performance.

That is, when the separate assembly 200 is coupled to the air conditioning case 110, the sealing surface 210 of the separate assembly 200 is positioned in the cut portion 151 to support the defrost door 117. As described above, the cut portion 151 and the separate assembly 200 are formed downstream of the defrost door 117 in the airflow direction.

To insert the thin sliding-type defrost door 117 into the rail part 150 formed in the air conditioning case 110, a portion of the rail part 150 is removed, and the defrost door 117 is pushed into the rail part 150 through the empty space, from which the portion of the rail part 150 is removed, for assembly. Furthermore, the separate assembly 200 is created by integrally forming the sealing surface 210 with a member serving as a discharge port grille of the defrost vent 115.

Due to the structure of the separate assembly 200 with the integrated sealing surface 210 and vent part 240, when the separate assembly 200 is coupled to the discharge port of the defrost vent 115 in the air conditioning case 110, the sealing surface 210 closely contacts by the tension part 137 of the defrost door 117. Therefore, the sealing surface 210 of the separate assembly 200 fills the empty space created by the cut portion 151 formed for assembling the defrost door 117, thereby providing both the sealing function and the function to guide the sliding of the defrost door 117. Ultimately, the configuration of the cut portion 151 and the separate assembly 200 improves the ease of assembly for the door and prevents air leakage.

The air conditioner for a vehicle according to the present invention has been described with reference to the embodiments shown in the drawings, but the embodiments are merely examples. It should be apparent that modifications and variations can be made by persons skilled without deviating from the spirit or scope of the present invention. Therefore, the true scope of technical protection should be defined by the spirit of the appended claims.

What is claimed is:

1. An air conditioner for a vehicle comprising:
an air conditioning case in which an air passage and a plurality of air discharge ports are formed;
a cooling heat exchanger and a heating heat exchanger sequentially arranged in the air passage of the air conditioning case in an airflow direction; and
a sliding-type door for adjusting the opening degree of the air passage,
wherein a rail part is formed in the air conditioning case to guide the sliding of the door, and
wherein a separate assembly is coupled to the air conditioning case and is in close contact with the door inserted into the rail part to form a sealing surface.

2. The air conditioner for a vehicle according to claim 1, wherein the separate assembly is detachably coupled to the air conditioning case.

3. The air conditioner for a vehicle according to claim 2, wherein the door has a thin plate shape, and
wherein the rail part supports at least one side of the door in a door thickness direction.

4. The air conditioner for a vehicle according to claim 3, wherein a cut portion is formed on one side of the rail part in the door thickness direction, and
wherein the door is inserted and assembled through the cut portion.

5. The air conditioner for a vehicle according to claim 4, wherein when the separate assembly is coupled to the air conditioning case, the sealing surface of the separate assembly is positioned in the cut portion to support the door.

6. The air conditioner for a vehicle according to claim 4, wherein the separate assembly has a mesh-shaped vent part.

7. The air conditioner for a vehicle according to claim 5, wherein the door is a mode door for adjusting the opening degree of the air discharge port, and
wherein the separate assembly includes a discharge port grille to prevent the ingress of foreign objects.

8. The air conditioner for a vehicle according to claim 7, wherein the mode door includes a defrost door for adjusting the opening degree of a defrost vent that directs air towards the window, and
wherein the separate assembly covers the discharge port of the defrost vent.

9. The air conditioner for a vehicle according to claim 1, wherein the separate assembly and the sealing surface are integrally formed.

10. The air conditioner for a vehicle according to claim 2, wherein the separate assembly has a coupling part of a hook-type fastening structure to be detachably coupled to the air conditioning case.

11. The air conditioner for a vehicle according to claim 3, wherein the internal passage of the air conditioning case is formed vertically relative to the ground surface to direct the airflow route from the bottom to the top in the direction of gravity, and
wherein the cooling and heating heat exchangers on the internal passage are sequentially arranged from the bottom to the top corresponding to the air flow route formed from the bottom to the top in the direction of gravity.

12. The air conditioner for a vehicle according to claim 7, wherein the separate assembly has a shape corresponding to that of the discharge port of the air discharge port, and
wherein the sealing surface is formed on both sides and the central part of the separate assembly in the vehicle width direction, and the sealing surface formed at the central part corresponds to a separator that divides the air passage of the air conditioning case in the vehicle width direction.

13. The air conditioner for a vehicle according to claim 5, wherein the cut portion and the separate assembly are formed downstream of the door in the airflow direction.

14. The air conditioner for a vehicle according to claim 4, wherein the door is inserted and assembled into the rail part from the outside of the air conditioning case through the air discharge port.

15. The air conditioner for a vehicle according to claim 4, wherein the door has a tension part that is elastically supported on the rail part, and
wherein the side of the door which contacts the sealing surface is formed on the opposite side where the tension part is formed.

16. The air conditioner for a vehicle according to claim 15, wherein the cut portion is formed on the opposite side of the tension part of the door.
